(19) United States
(12) Patent Application Publication
(10) Pub. No.: US 2026/0149336 A1
(43) Pub. Date: May 28, 2026

(54) MOTOR

(71) Applicant: MITSUBA Corporation, Gunma (JP)

(72) Inventors: TAKAHIRO NAGAI, Gunma (JP); YUTA SUZUKI, Gunma (JP); KAZUAKI KOBAYASHI, Gunma (JP); DAI YAMAMOTO, Gunma (JP); KEITA NAKABAYASHI, Gunma (JP)

(73) Assignee: MITSUBA Corporation, Gunma (JP)

(21) Appl. No.: 18/714,084

(22) PCT Filed: Sep. 4, 2023
(86) PCT No.: PCT/JP2023/032190

§ 371 Date: May 28, 2024

(30) Foreign Application Priority Data
Dec. 16, 2022 (JP) 2022-201167

(51) Int. Cl. H02K 11/25; H02K 3/46

(52) U.S. Cl. CPC H02K 11/25; H02K 3/46

(57) ABSTRACT

Provided is a motor that is able to properly detect a temperature of a high-temperature position of a wire coil and can be assembled easily.

A motor 1 includes: a stator 3; a rotor 2, rotatably installed; an insulator 11, installed to the stator 3, and having a cylindrical shape which exhibits an insulating property and in which wire winding parts 11d are arranged in a peripheral direction; wire coils 12, formed by winding wires 12a about the respective wire winding parts 11d of the insulator 11; and a temperature detection sensor 13, detecting a temperature of the wire coil 12. An opening part 15e for bringing the temperature detection sensor 13 into contact with the wire coil 12 is provided on an outer peripheral side of at least one wire winding part 11d. The opening part 15e is formed along a lamination direction of the wire coil 12.

### TECHNICAL FIELD

The disclosure relates to a motor, such as a so-called brushless motor.

### RELATED ART

In recent years, efforts have been made on an international scale to promote the Sustainable Development Goals (Sustainable Development Goals, 2030 Agenda for Sustainable Development, adopted by the United Nations Summit on Sep. 25, 2015, hereinafter referred to as “SDGs”). Specifically, the goals of the SDGs include “Goal 9: Create a foundation for industry and technological innovation” and “Goal 12: Responsibility to create and use”, and technological development aiming at solving these goals is desired.

As a technique that can make contribution to solve these goals, the technique recited in Patent Document 1 is known. Patent Document 1 discloses: “In the rotary electric machine according to the invention, insulators, which have trunk portions and a pair of flange portions linked to two ends of the trunk portions in the longitudinal direction, are respectively disposed such that longitudinal directions of trunk portions are oriented in a radial direction of teeth, and so as to place bottom surfaces of the trunk portions alongside two axial end surfaces of the teeth, concentrated winding coils are configured by winding conductor wires so as to be wound in multiple layers around the teeth so as to pass through a concave space that is formed by the trunk portions and first and second flange portions at two axial ends of the teeth. One of the pair of flange portions is disposed on an end surface of a core back of a stator core, and a temperature detecting element is installed by being inserted into an element insertion aperture that is formed on the flange portion so as to be able to detect a temperature of a coil end of the concentrated winding coils.”

### PRIOR ART DOCUMENT(S)

### Patent Document(s)

[Patent Document 1: WO 2014/132359

### SUMMARY OF INVENTION

### Technical Problem

In general, in a wire coil, there is a tendency that the heat on the inner layer side may be difficult to dissipate and the temperature may easily increase. Meanwhile, in the rotary electric machine disclosed in Patent Document 1, it is possible to detect the temperature of a coil end of a concentrated winding coil by using a temperature detection element (wire coil) inserted into an element insertion aperture formed in one of the flange portions. Therefore, an issue that the temperature of a high-temperature position of the concentrated winding coil cannot be properly detected may arise.

In addition, in the rotary electric machine disclosed in Patent Document 1, it is configured that the element insertion hole is formed at one of the flange portions, and the temperature detection element is inserted into the element insertion aperture to detect the temperature of the coil end of the concentrated winding coil. Thus, since it is necessary to press-fit the temperature detection element between the concentrated winding coil and the flange portion by elastically deforming the element insertion aperture or the temperature detection element, etc., an issue of difficulty in assembling may also arise.

The disclosure has been made to solve the above issues, and an objective of the disclosure is to provide a motor capable of properly detecting the temperature of a high-temperature position of a wire coil and being easy to assemble.

### Means for Solving the Issues

An aspect of the disclosure provides a motor. The motor includes: a stator; a rotor, rotatably installed; an insulator, installed to the stator, and having a cylindrical shape which exhibits an insulating property and in which wire winding parts are arranged in a peripheral direction; wire coils, formed by winding wires about the respective wire winding parts of the insulator; and a temperature detection sensor, detecting a temperature of the wire coil. An opening part for bringing the temperature detection sensor into contact with the wire coil is provided on an outer peripheral side of at least one of the wire winding parts. The opening part is formed along a lamination direction of the wire coil.

### Inventive Effects

According to the disclosure, the temperature of a high-temperature position of a wire coil can be properly detected, and assembling is easy.

### BRIEF DESCRIPTION OF DRAWINGS

FIG. 1 is a side view illustrating a motor according to an embodiment of the disclosure.

FIG. 2 is a view as a cross-sectional view in which a portion of the motor is cut off in the axial direction.

FIG. 3 is a partial perspective view of the motor.

FIG. 4 is a partial radial cross-sectional view of the motor.

FIG. 5 is a partial axial cross-sectional view of the motor.

FIG. 6 is a side view in which a portion of the motor is cut off.

FIG. 7 is a perspective view illustrating an insulator of the motor.

FIG. 8 is a perspective view illustrating a thermistor of the motor.

FIG. 9 (A) of FIG. 9 is a view illustrating a plate spring member of the motor, and (B) of

FIG. 9 is a perspective view from the inner side.

FIG. 10 is a perspective view illustrating a busbar unit of the motor from a rear side.

FIG. 11 is a perspective view illustrating the busbar unit from a front side.

FIG. 12 is a schematic view illustrating a state in which the motor is installed to a side-mounted type electric motorcycle.

FIG. 13 is a schematic view illustrating a state in which the motor is installed to a center-mounted type electric motorcycle.

FIG. 14 is a flowchart illustrating a manufacturing process of the motor.

### DESCRIPTION OF EMBODIMENTS

### An Embodiment

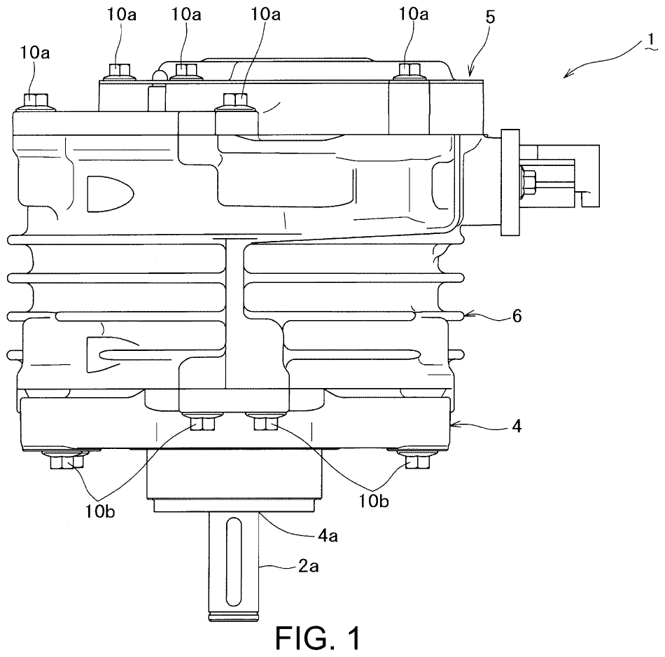

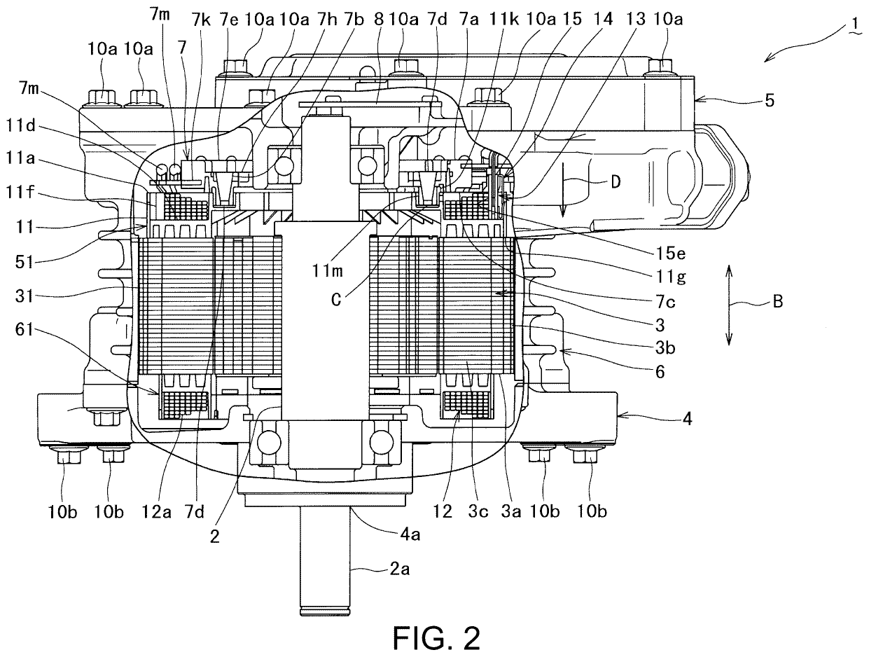

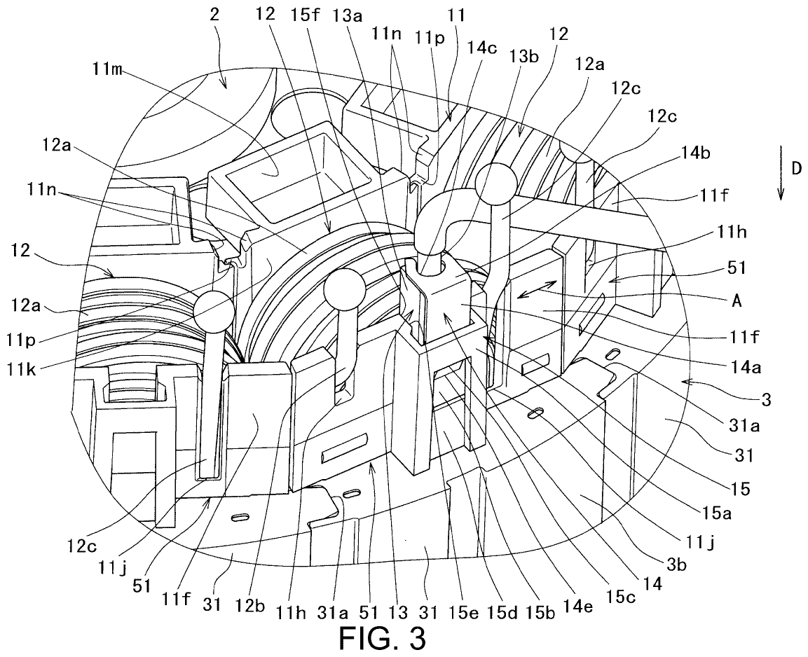

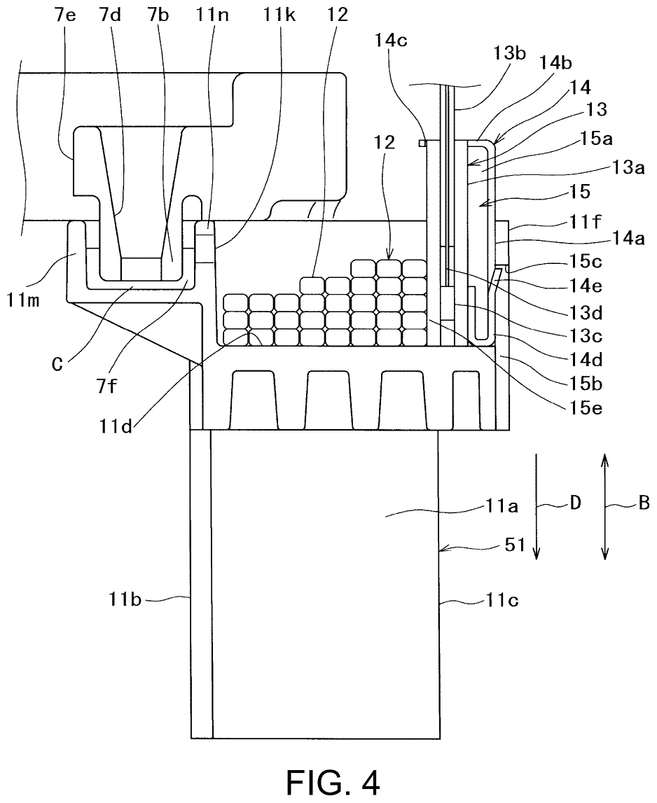

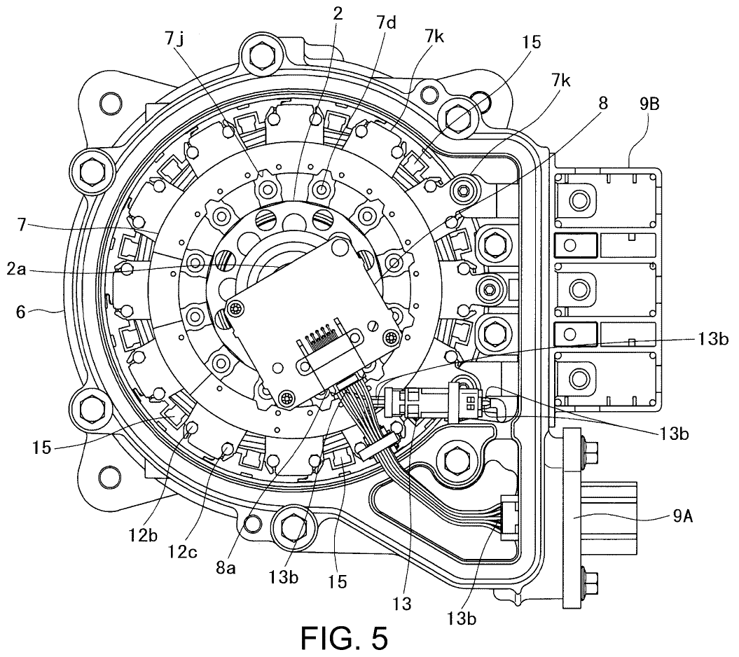

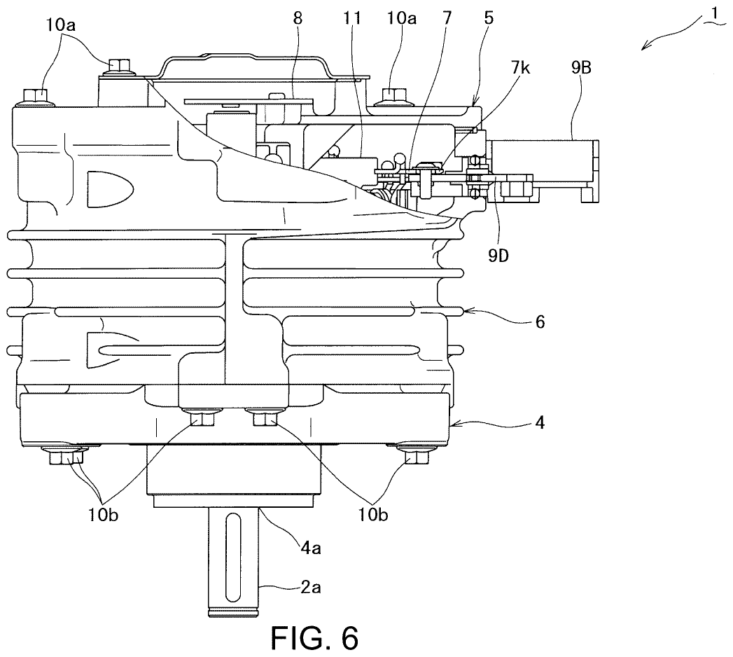

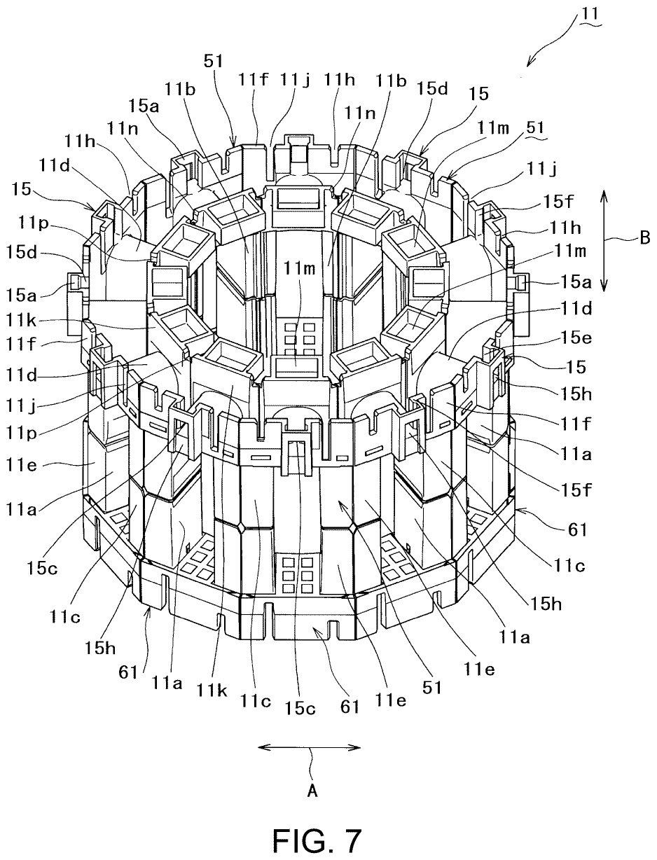

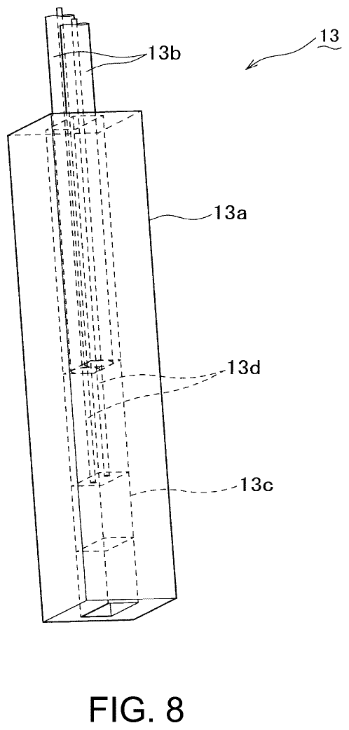

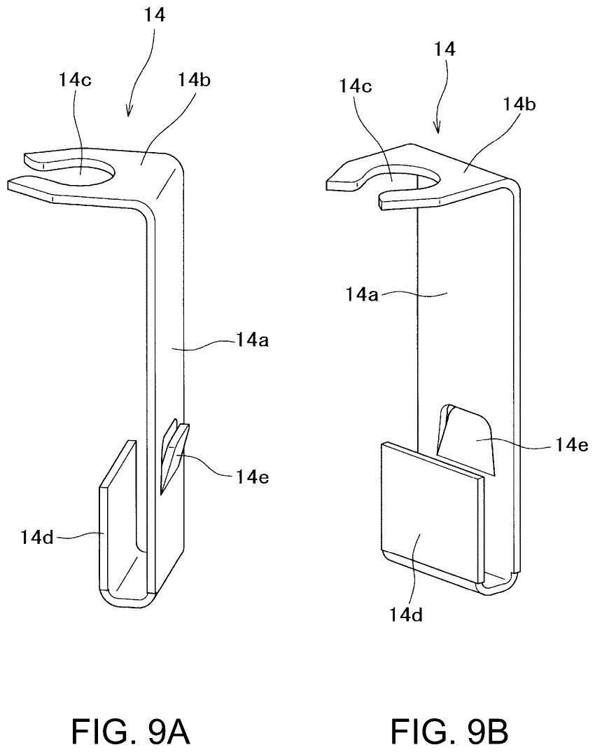

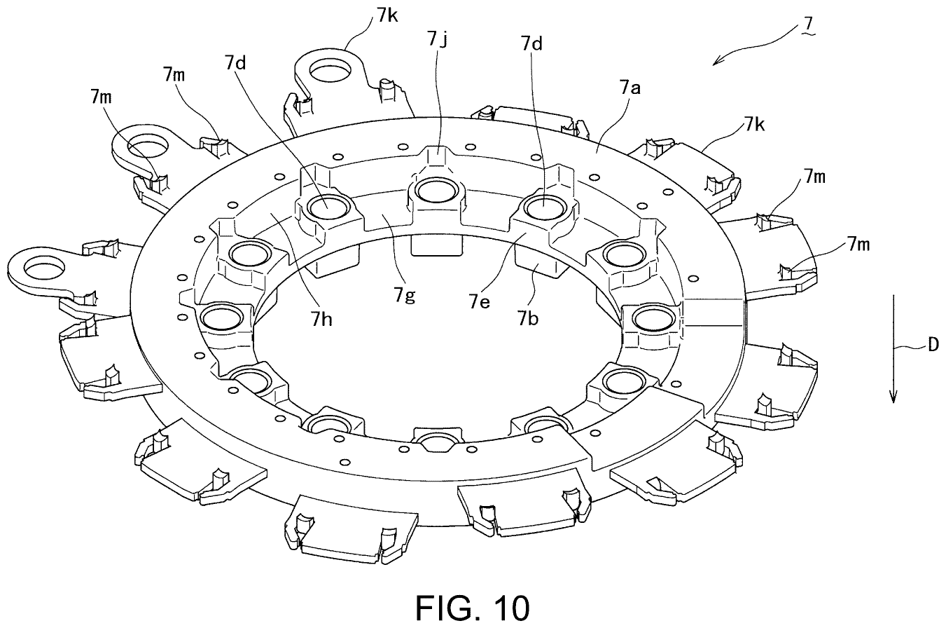

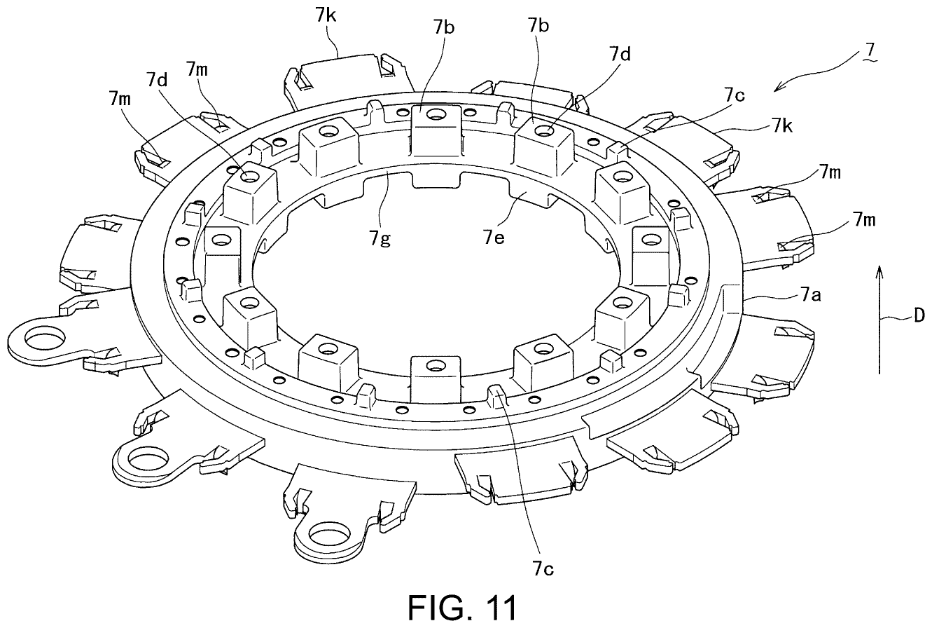

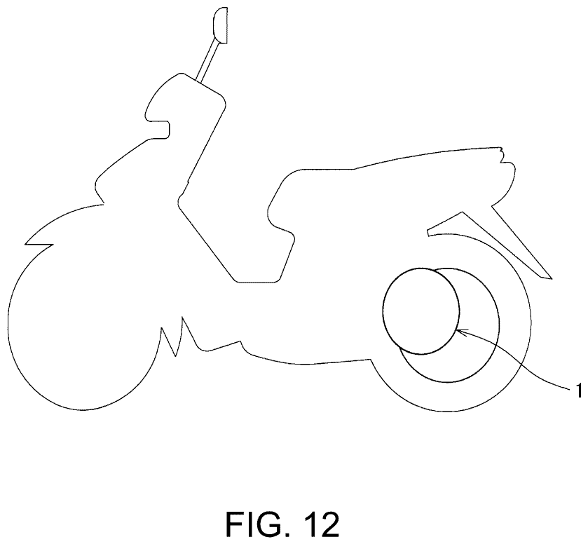

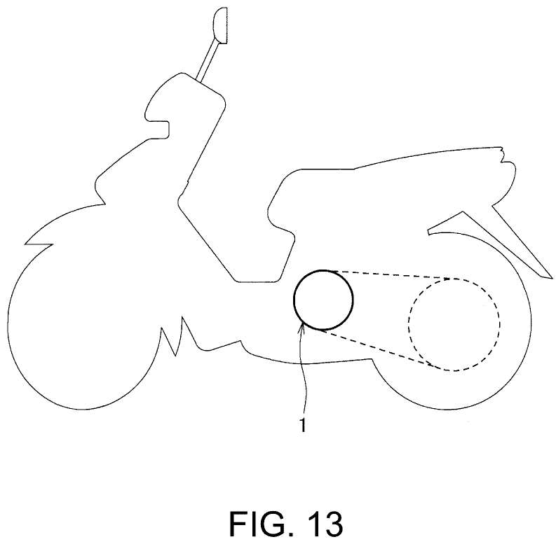

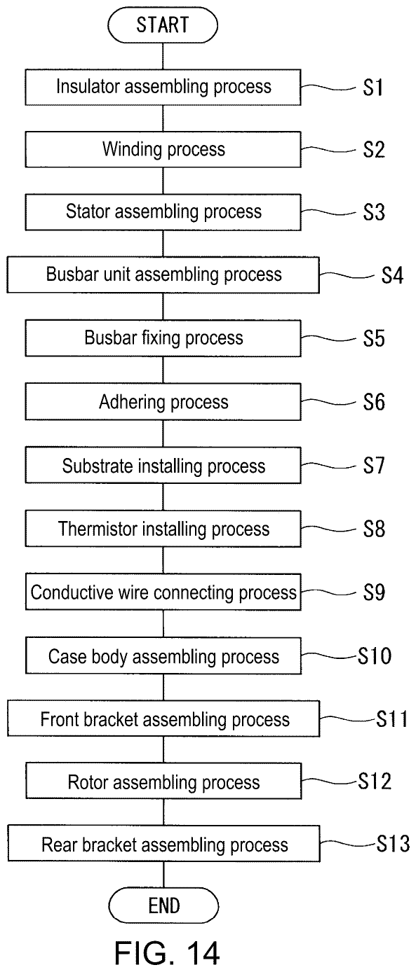

In the following, an embodiment of the disclosure is described with reference to the drawings. FIG. 1 is a side view illustrating a motor according to an embodiment of the disclosure. FIG. 2 is a view as a cross-sectional view in which a portion of the motor is cut off in the axial direction. FIG. 3 is a partial perspective view of the motor. FIG. 4 is a partial radial cross-sectional view of the motor. FIG. 5 is a partial axial cross-sectional view of the motor. FIG. 6 is a side view in which a portion of the motor is cut off. FIG. 7 is a perspective view illustrating an insulator of the motor. FIG. 8 is a perspective view illustrating a thermistor of the motor. (A) of FIG. 9 is a view illustrating a plate spring member of the motor, and (B) of FIG. 9 is a perspective view from the inner side. FIG. 10 is a perspective view illustrating a busbar unit of the motor from a rear side. FIG. 11 is a perspective view illustrating the busbar unit from a front side. FIG. 12 is a schematic view illustrating a state in which the motor is installed to a side-mounted type electric motorcycle. FIG. 13 is a schematic view illustrating a state in which the motor is installed to a center-mounted type electric motorcycle. FIG. 14 is a flowchart illustrating a manufacturing process of the motor.

### Overall Configuration

A motor 1 according to the embodiment is a so-called brushless motor and is called a three-phase motor. The motor 1 is used, for example, as a drive motor for an electric motorcycle that is driven frequently and requires high durability, etc. For example, the motor 1 is used as a drive motor of a side-mounted type electric motorcycle that performs driving on a side of the drive wheel, as shown in FIG. 12, or as a drive motor of a center-mounted type electric motorcycle that performs driving between the front wheel and the rear wheel.

In addition, the motor 1 is an interior permanent magnet (IPM) motor in which a magnet (permanent magnet) is embedded in a rotor 2. Specifically, as shown in FIG. 2, the motor 1 includes a stator 3 having a cylindrical shape, and has a configuration of an inner rotor type in which the rotor 2 is concentrically and rotatably installed on the inner side of the stator 3. The rotor 2 is rotatably supported around a rotary shaft 2a. In the following, unless the reference is specifically specified, the peripheral direction, the axial direction, and the radial direction are defined with the axis of the rotary shaft 2a as a reference.

A front bracket 4 and a rear bracket 5 as a cover body are installed to two ends of the stator 3 in the axial direction, and a case body 6 as a housing is installed between the front bracket 4 and the rear bracket 5. An insertion hole 4a as an opening through which an end of the rotary shaft 2a of the rotor 2 is inserted through to protrude is provided at the front bracket 4. In the following, the side where the front bracket 4 is located is defined as the front side, and the side where the rear bracket 5 is located is defined as the rear side.

The case body 6 is formed in a substantially cylindrical shape with openings on the front side and the rear side, respectively. As shown in FIGS. 1 and 2, the motor 1 forms a three-split structure of the front bracket 4, the rear bracket 5, and the case body 6. In addition, in the motor 1, the stator 3 is mounted and fixed to the inner side of the case body 6, an end of the rotary shaft 2a protrudes from the insertion hole 4a of the front bracket 4, and the rotary shaft 2a is fixed between the front bracket 4 and the rear bracket 5 so that the rotor 2 is rotatable in the stator 3. A busbar unit 7 in an annular shape is installed concentrically to the end of the stator 3 on the rear side. A rotary sensor substrate 8 having a substantially rectangular plate shape is installed to the rear side of the busbar unit 7. Conductive wires (not shown) connected with a rotary sensor detecting the rotation speed of the rotor 2, for example, is connected with the rotary sensor substrate 8. The rotary sensor substrate 8 is installed to a position eccentric from the rotation center of the rotary shaft 2a. In addition, as shown in FIGS. 5 and 6, an output connector 9A is installed to the outer peripheral part of the case body 6. The output connector 9A is provided for pulling out each conductive wire connected with a connector 8a of the rotary sensor substrate 8. In addition, a terminal holder 9B adjacent to the output connector 9A is installed to the outer peripheral part of the case body 6. The terminal 9B is electrically connected with a predetermined busbar terminal 7k of the busbar unit 7 via a terminal 9D.

The stator 3 includes a stator core 3a formed by laminating multiple electromagnetic steel plates. The stator core 3a is press-fit into the case body 6. In addition, the front bracket 4 on the front side of the case body 6 is fixed by a bolt 10b, and the rear bracket 5 on the rear side of the case body 6 is fixed by a bolt 10a. It is noted that the front bracket 4 and the rear bracket 5 are fixed to the case body 6 by individual bolts 10b, 10a. The stator core 3a includes a cylindrical stator core body 3b and multiple teeth 3c protruding from the inner peripheral side of the stator core body 3b toward the radially inner side. As an example, 12 teeth 3c are provided at equal intervals in the peripheral direction. An insulator 11 is installed to each tooth 3c, and a wire coil 12 is wound around each tooth 3c via the insulator 11. The stator 3 is split into 12 portions in the peripheral direction, and a portion of the 12-split stator portions is configured as a stator member 31. The stator member 31 is formed in the same shape having a portion of the 12-split stator core body 3b and the tooth 3c. In addition, on the end surface of the portion corresponding to the stator core body 3b in each stator member 31 in the peripheral direction, an uneven surface 31a fit with each other is formed. The stator 3 has a configuration having the insulator 11 and a total of 12 wire coils 12.

The insulator 11 is formed by two components made of a synthetic resin having an insulating property, and is installed to the teeth 3c from the respective two end sides of the motor 1 in the axial direction. In addition, the outer diameter dimension of the insulator 11 is formed to be smaller than the outer diameter dimension of the stator 3. Specifically, the insulator 11 includes, for example, 24 insulator bodies 11a in which the inner peripheries penetrate in a rectangular shape and the outer peripheries are formed in an oval shape, so as to cover the outer periphery surfaces of the teeth 3c. The insulator 11 is arranged in a state in which the axial directions of the total of 24 insulator bodies 11a are arranged in the radial direction of the motor 1 and the insulator bodies 11a are arranged at equal intervals in the peripheral direction. In addition, the stator core body 3b is installed by protruding toward the outer peripheral side of each insulator body 11a of the insulator 11.

An inner flange 11b is provided throughout the entire periphery on the peripheral edge of each insulator body 11a on the side of the stator core body 3b. In addition, an outer flange 11c is provided throughout the entire periphery on the peripheral edge of the tip end side of the tooth 3c on a side opposite to the inner flange 11b of the insulator body 11a. In addition, by using the insulator body 11a, the inner peripheral flange 11b and the outer peripheral flange 11c, a wire winding part 11d for mounting the wire coil 12 is formed. The wire coil 12 is mounted to each wire winding part 11d. The winding wire 12 is formed by winding a wire 12a multiple times from the inner peripheral side toward the outer peripheral side. The wire coil 12 is installed to the wire winding part 11d by winding the wire 12a using the axial direction as the central axis direction. As shown in FIG. 7, the wire winding parts 11d are arranged by being separated at equal intervals in the peripheral direction.

The wire 12a is a flat wire having an elongated rectangular cross-sectional shape and a conductive property. The surface of the wire 12a is covered by an insulating material. The wire 12a is wound by bringing a side surface of this wire 12a into contact with the wire winding part 11d, and is further wound by being laminated while bringing the side surface of the wire 12a into the other side surface of the wire 12a that has been wound. In addition, the wire 12a is wound to be adjacent to and contact the wire 12a that has been wound while alternately changing the winding direction from the outer peripheral side of the wire winding part 11d to the inner peripheral side and further from the inner peripheral side toward the outer peripheral side. The wires 12a are finally arranged in a state of being adjacent radially, and form the wire coil 12 by being arranged as windings aligned from the inner peripheral side of the wire winding part 11d toward the outer peripheral side or from the outer peripheral side to the inner peripheral side.

In the outer peripheral flange 11c of the insulator 11, two side parts contacting the stator core body 3b of the stator core 3a are arranged as stator core receiving parts 11e in a plate shape. In addition, in the outer peripheral flange 11c, an axial end part which the stator core body 3b does not contact is arranged as an outer wall part 11f in a plate shape. The outer wall part 11f is formed to be thicker than the stator core receiving part 11e, and is formed in a collar shape in which the outer side surface of the outer wall part 11f is more protrusive toward the outer side than the outer side surface of the stator core receiving part 11e. As a result, a configuration as follows is formed: a base part 11g is formed between the outer wall part 11f and the stator core receiving part 11e, and the stator core body 3b is fit between the base parts 11g of the outer wall parts 11f located at two ends in the axial direction.

The respective outer wall parts 11f of the insulator 11 each have a width direction A orthogonal to the axial direction and the radial direction, respectively, and form a state of being arranged in the peripheral direction, so as to form a dodecagonal shape when viewed in the axial direction. On the end surface of each outer wall part 11f on the rear side or the front side, a pair of wire fitting groove parts 11h, 11j are provided separately at a predetermined interval. The wire fitting groove parts 11h, 11j are open on the end surface side of the outer wall part 11f, and are formed in a concave groove shape penetrating through the outer wall part 11f in the thickness direction. In addition, the wire fitting groove part 11h is shallower than the other wire fitting groove part 11j in the axial direction, and, in brief, formed in a shape of a small notch.

A start point part 12c, which is the base part side of the wire 12a when the wire 12a starts being wound on the wire winding part 11d, is fit with and temporarily fixed to the wire fitting groove part 11h. An end point part 12b protruding from the outer peripheral side of the wire 12a in a state in which the wire 12a is wound on the wire bonding part 11d to form the wire coil 12 is fit with and temporarily fixed to the other wire fitting groove part 11j. That is, in the wire coil 12, in the state in which the start point part 12c of the wire 12a is temporarily fixed to the wire fitting concave part 11h, this wire 12a is gradually wound from the inner layer side toward the winding wire part 11d. Then, the end point part 12b of this wire 12a is temporarily fixed to the wire fitting concave part 11j to be drawn out and guided to the outer peripheral side of the insulator 11.

In addition, as shown in FIG. 7, the insulator 11 is formed in a two-split configuration in the axial direction. The half portion on the rear side that is obtained by being split into two is split into 12 portions in the peripheral direction, and one of the 12 split portions of the insulator 11 is configured as a rear-side insulator member 51. The rear-side insulator members 51 are each configured in the same shape having the rear-side half of the insulator body 11a, the inner peripheral flange 11b, and the outer peripheral flange 11c. In addition, the half portion on the front side that is obtained by splitting the insulator 11 into two in the axial direction is also split into 12 portions in the peripheral direction. One of the 12 split portions of the insulator 11 is configured as a front-side insulator member 61. The front-side insulator members 61 are also each configured in the same shape having the front-side half of the insulator body 11a, the inner peripheral flange 11b, and the outer peripheral flange 11c.

### Fixing Configuration of the Insulator 11

In the inner peripheral flange 11b of each rear-side insulator member 51, an inner wall part 11k is formed at the axial end facing a sensor installation part 15. The inner wall part 11k is formed to be thicker than the stator core receiving part 11e, and is formed in a collar shape in which the inner side surface of the inner wall part 11k is more protrusive toward the inner side than the inner side surface of the stator core receiving part 11e. In addition, on the inner side of the inner wall part 11k, an insertion receiving part 11m is provided to protrude in the inner diameter direction. As shown in FIGS. 3, 4, and 7, the insertion receiving part 11m is formed in a concave cross-sectional shape and in a saucer shape in which the rear side is open. The insertion receiving part 11m is provided in each rear-side insulator member 51. A total of 12 insertion receiving parts 11m are configured to be arranged at equal intervals in the peripheral direction of the insulator 11. In addition, in the state in which the rotor 2 is attached to the stator 3, each insertion receiving portion 11m is provided to protrude in the inner diameter direction to a position that covers a portion of the rotor 2, that is, the outer peripheral edge of the rotor 2.

In addition, at the two ends of the inner wall part 11k of each rear-side insulator member 51 in the width direction A, the two end parts are notched to form fitting stepped parts 11n. The fitting stepped parts 11n are provided at corner parts of the inner wall part 11k on the rear side, and, in the state in which the total of 12 rear-side insulator members 51 are assembled, concave fitting groove parts 11p are formed by adjacent fitting stepped parts 11n. In brief, the fitting groove part 11p is located between the insertion receiving parts 11m of the insulator 11, and the total of 12 fitting groove parts 11p are configured to be arranged at equal intervals in the peripheral direction on the rear side of the insulator 11.

The busbar unit 7 is fixed concentrically on the rear side of the insulator 11. The busbar unit 7 supplies power to each wire coil 12 and, as shown in FIGS. 4, 10, and 11, includes a busbar unit body 7a in a substantially annular shape. At a position near the front side of the inner peripheral side of the busbar unit body 7a, an insertion fixing part 7b is provided as an insulator fixing part to be inserted into the insertion receiving part 11m of the insulator 11. The busbar unit body 7a is formed with a thickness in the axial direction greater than the thickness of the insertion fixing part 7b. The insertion fixing part 7b protrudes toward the front side, and is formed in a prismatic shape that is a protrusion inserted into the insertion receiving part 11m from the rear side. In addition, a total of 12 insertion fixing parts 7b are configured to be arranged at equal intervals in the peripheral direction. In addition, in the state in which the rotor 2 is disposed on the outer periphery of the stator 3, each insertion fixing part 7b is provided to protrude in the inner diameter direction to a position that covers a portion of the rotor 2, that is, in brief, the outer peripheral edge of the rotor 2.

As shown in FIG. 11, a total of 12 locking convex parts 7c are provided on the bottom surface part located on the front side of the busbar unit body 7a. At the time when the busbar unit 7 is fixed concentrically to the rear side of the insulator 11, the locking convex parts 7c are configured to be fit into the fitting groove parts 11p of the insulator 11. In the busbar unit 7, a predetermined clearance is configured to be formed with which the bottom surface of the busbar unit 7 on the front side does not contact the surface of the wire coils 12 on the rear side. The locking convex parts 7c make position-fitting of the busbar unit 7 with respect to the insulator 11 in the peripheral direction easy, and are configured to limit the movement of the busbar unit 7 with respect to the insulator 11 in the rotation direction to position fixedly.

In addition, the busbar unit 7 is configured so that in the state in which the locking convex parts 7c of the busbar unit 7 are fit into the fitting groove parts 11p of the insulator 11 to be positioned and fixed and the insertion fixing parts 7b of the busbar unit 7 are inserted into the insertion receiving parts 11m of the insulator 11, as shown in FIG. 4, the predetermined clearances C serving as bonding positions are formed between the bottom surfaces of the insertion fixing parts 7b of the busbar unit 7 on the front side and the bottom surfaces of the insertion receiving 11m of the insulator 11.

In addition, a leg part 7e having a through hole 7d penetrating through the insertion fixing part 7b is provided on the rear side of each insertion fixing part 7b of the busbar unit body 7a. The leg part 7e protrudes toward the inner peripheral side of the busbar unit body 7a with respect to the insertion fixing part 7b. The through hole 7d penetrates through from the rear side of the leg part 7e to the front side of the insertion fixing part 7b, and is formed in a conical shape, in brief, a funnel shape, whose diameter decreases along an insertion direction D for inserting the insertion receiving part 11m of the insulator 11 into the insertion fixing part 7b. In addition, the through hole 7d has a length dimension that is the sum of the thickness dimension of the leg part 7a and the thickness dimension of the insertion fixing part 7b, and the internal volume of the through hole 7d is designed to be greater than the filling amount of an adhesive 7f filled into the through hole 7d. In addition, as shown in FIG. 4, the through hole 7d serves as an adhesive filling port with which the adhesive 7f having a fluid property is filled into the clearance C between the insertion fixing part 7b and the insertion receiving part 11m from the rear side, the side surface of the insertion fixing part 7b is soaked in the adhesive 7f, and the insertion fixing part 7b and the insertion receiving part 11m are adhered and fixed.

In addition, each leg part 7e is linked with an inner peripheral collar part 7g in a plate shape in the peripheral direction, and protrudes toward the rear side with respect to each inner peripheral collar part 7g. A stepped part 7h is formed between each inner peripheral collar part 7g and the inner peripheral surface of the busbar unit body 7a. In addition, in a portion of the stepped part 7h on the outer peripheral side of the leg part 7e, a concave stepped part 7j is formed by recessing the inner peripheral surface of the busbar unit body 7a in a concave shape.

On the outer peripheral part of the busbar unit 7a, a collar-shaped busbar terminal 7k serving as a coil connection part positioning and fixing the start point part 12c and the end point part 12b of each wire coil 12 is formed. Each busbar terminal 7k protrudes toward the outer peripheral side along the radial direction, and a total of 12 busbar terminal 7k, matching the number of the wire coils 12, are arranged at equal intervals in the peripheral direction. On the outer peripheral edge of each busbar terminal 7k, the start point part 12c or the end point part 12b of the wire coil 12 is welded and electrically connected with a pair of connection parts 7m.

### Temperature Detection Configuration

A thermistor 13 and a plate spring member 14 are installed to the outer periphery of the insulator 11. The thermistor 13 detects the temperature of the wire coil 12. The plate spring member 14 biases the thermistor 13 to the wire coil 12. The thermistor 13 and the plate spring member 14 are installed to a thermistor accommodation part 15 provided on the outer side of the outer wall part 11f located on the rear side of the insulator 11. In brief, the thermistor accommodation part 15 is provided in each rear-side insulator member 51. In addition, the thermistor accommodation part 15 is provided between the pair of wire fitting groove parts 11h, 11j located on the outer side of the outer wall part 11f, and is provided at the central position on the outer side surface of the outer wall part 11f in the width direction A. That is, the thermistor accommodation part 15 is located and provided between the start point part 12c and the end point part 12b of the wire coil 12.

In addition, the thermistor accommodation part 15 further includes an installation concave part 15a into which the thermistor 13 is fit from the rear side. The installation concave part 15a is provided along the axial direction and formed in a box shape protruding toward the outer peripheral side of the insulator 11, that is, in brief, the outer side of the outer wall part 11f. In addition, the installation concave part 15a is provided from the end of the outer wall part 11f on the rear side until the position along the outer peripheral surface of the wire winding part 11d. In addition, as shown in FIGS. 3 and 4, in the installation concave part 15a, the bottom part of the installation concave part 15a on the front side contacts the surface of the stator core body 3b on the rear side and has a function of preventing the insulator 11 from falling down.

On the outer side surface of the installation concave part 15a, a locking groove 15b penetrating through the installation concave part 15a is provided. The locking groove 15b is formed in a rectangular shape, and the opening edge of the locking groove 15b on the rear side forms a locking surface 15c perpendicular to the outer wall part 11f. In addition, on the side of the insulator body 11a on the outer side surface of the installation concave part 15a, an accommodation concave part 15d in a concave cross-sectional shape is provided. The accommodation concave part 15d is provided continuously on the side of the insulator body 11a in the locking groove 15b. In addition, the accommodation concave part 15d provided from the opening edge positioned on a side opposite to the locking surface 15c of the accommodation concave part 15d to the end part on the rear side in the height direction perpendicular to the width direction A.

In addition, in the thermistor accommodation part 15, an opening part 15e bringing the thermistor 13 installed to the installation concave part 15a into contact with the wire coil 12 is formed. The opening part 15e penetrates to the rear side and is formed in a width dimension slightly smaller than a width dimension of the installation concave part 15a. In addition, the opening part 15e is arranged in a notched shape that is concave from the end of the outer wall part 11f on the rear side to the outer peripheral surface of the wire winding part 11d. The opening part 15e is provided along the axial direction at the central position in the width direction A. Therefore, at the central position of the wire coil 12 wound on the wire winding part 11d in the width direction A, the opening part 15e is provided along a lamination direction B that is a winding direction of the wire 12a of the wire coil 12. As a result, the thermistor 13 is installed to the thermistor accommodation part 15, so as to contact multiple wires 12a located on the inner layer of the wire coil 12, along the lamination direction B of the wire coil 12 from the opening part 15e.

In addition, on two side parts of the opening part 15e in the width direction A, locking pieces 15f where inner pieces of the installation concave part 15a protrude are provided. The locking pieces 15f are located in the vicinities of the two side parts of the thermistor 13 installed to the installation concave part 15a, and limits the movement of the thermistor 13 in the width direction A.

As shown in FIG. 8, the thermistor 13 includes a thermistor body 13a in an elongated, rectangular cross-sectional shape. The thermistor 13 is configured so that a pair of conductive wires 13b are drawn out from an end side in the longitudinal direction of the thermistor body 13a. In addition, a detection element 13c serving as a reference point for temperature detection is accommodated inside the thermistor part 13a. The detection element 13c is installed to a position at a predetermined interval to an end side from the other end surface of the thermistor body 13a. In addition, a pair of lead wires 13d are connected to an end side of the detection element 13c in the longitudinal direction of the thermistor body 13a. In addition, the ends of the pair of lead wires 13d are electrically connected with a pair of conductive wires 13b.

The plate spring member 14 is a biasing member that biases the thermistor 13 toward the wire coil 12. As shown in (A) and (B) of FIG. 9, the plate spring member 14 includes a plate spring body 14a in a thin, elongated plate shape. In the plate spring body 14a, an end side is bent in an L shape, and the other end is arranged in a shape bent in a V shape in the same direction with the end side. The plate spring body 14a is configured to have an elastic force that biases the thermistor 13 to the wire coil 12. In addition, an insertion concave part 14c is provided at a bent part 14b bent in an L shape on the end side of the plate spring body 14a. The insertion concave part 14c is in a concave shape into which the conductive wires 13b protruding from the thermistor 13 are inserted through. The bent part 14b is configured so that the conductive wires 13b of the thermistor 13 are inserted through the insertion concave part 14c, and is configured to hold the base end side of the thermistor body 13a of the thermistor 13 installed to the thermistor accommodation part 15.

Meanwhile, a U-shaped elastic piece 14d on the other end side of the plate spring body 14a is inserted, together with the thermistor 13, into the installation concave part 15a of the thermistor accommodation part 15, and locks the thermistor 13. In addition, the elastic piece 14d is configured to bias the thermistor 13 installed to the thermistor accommodation part 15 toward the side of the wire coil 12 by using the elastic force of the elastic piece 14d. In addition, a retaining piece 14e protruding toward the opposite side in the bending direction of the bent part 14b is provided at the intermediate part of the plate spring body 14a in the longitudinal direction. The retaining piece 14e is formed by cutting and raising a portion of the plate spring body 14a. In addition, at the time when the plate spring member 14 is fit into the installation concave part 15a of the thermistor accommodation part 15 together with the thermistor 13, the retaining piece 14e is configured to be locked to the locking surface 15c of the thermistor accommodation part 15 and retain and hold the thermistor 13 toward the thermistor accommodation part 15. Thus, a so-called snap-fit configuration is formed.

In addition, as shown in FIG. 2, the thermistor 13 and the plate spring member 14 are installed one-by-one to only one thermistor accommodation part 15 among the rear-side insulator members 51 of the insulator 11. The thermistor 13 is configured to detect the temperature of one adjacent wire coil 12 among the wire coils 12. Here, the output side of one of the conductive wires 13b of the thermistor 13 is routed to the output connector 9A to be guided to the outside, as shown in FIG. 5. In addition, the ground side of the other of the conductive wires 13b is electrically connected to the rotary sensor substrate 8 via the connector 8a. Therefore, from the perspective of shortening the conductive wires 13b, considering the routing of the conductive wire 13b, the thermistor 13 is installed to the thermistor accommodation part 15 close to each of the connector 8a of the rotary sensor substrate 8 and the output connector 9A.

In addition, together with the plate spring member 14, the thermistor 13 is press-fit into and stored in the thermistor accommodation part 15. In addition, the thermistor 13 is pressed toward the side of the wire coil 12 by using the elastic force of the plate spring member 14 generated between the thermistor 13 and the outer peripheral surface of the thermistor accommodation part 15, and is brought into contact with the wire 12a located on the inner peripheral side of the wire coil 12 from the opening part 15e of the thermistor accommodation part 15. In addition, the thermistor 13 contacts and is fixed to multiple wires 12a located on the inner layer side of the wire coil 12.

### Manufacturing Method

In the following, the manufacturing processes of a manufacturing method of the motor 1 according to the embodiment are described with reference to FIG. 14.

### Insulator Assembling Process

Firstly, the insulator 11 is installed to the stator core 3a. At this time, the rear side insulator member 51 and the front insulator member 61 are assembled to form one wire winding part 11d (S1).

### Winding Process

In such state, the wire 12a is wound on the wire winding part 11d to mount the wire coil 12 (S2).

### Stator Assembling Process

Then, a total of 12 units are prepared, in which the rear-side insulator members 51 and the front-side insulator members 61 are assembled, the wire coils 12 are mounted, and the stator members 31 are fit. In addition, the side of the respective outer wall parts 11f of the total of 12 units is disposed in an arc shape in a state of facing the outer peripheral side. At this time, the facing uneven surfaces 31a of the adjacent stator members 31 are fit to form the arc-shaped stator 3 (S3).

### Busbar Unit Assembling Process

Then, the busbar unit 7 is installed to the rear side of the insulator 11 (S4) At this time, each insertion fixing part 7b of the busbar unit 7 is inserted into each insertion receiving part 11m of the insulator 11, and each locking convex part 7c of the busbar unit 7 is fit into each fitting groove part 11p of the insulator 11.

### Busbar Fixing Process

Then, the start point part 12c and the end point part 12b of each wire coil 12 installed to the insulator 11 are welded and fixed to the connection part 7m of each busbar terminal 7k of the busbar unit 7, and the start point part 12c and the end point part 12b of each wire coil 12 are electrically connected with a predetermined busbar terminal 7k (S5).

### Adhering Process

In such state, the adhesive 7f in a predetermined amount is injected into each through hole 7d of the busbar unit 7, the adhesive 7f is filled into and cured in the clearance C formed between the insertion fixing part 7b of the busbar unit 7 and the insertion receiving part 11m of the insulator 11, and the insertion fixing part 7b of the busbar unit 7 and the insertion receiving part 11m of the insulator 11 are adhered and fixed by the adhesive 7f (S6).

### Substrate Installing Process

Then, the rotary sensor substrate 8 is installed to the busbar unit 7 (S7).

### Thermistor Installing Process

Then, the base end of the conductive wire 13b of the thermistor 13 is inserted into the insertion concave part 14c of the plate spring member 14. In addition, the plate spring body 14a of the plate spring member 14a is arranged to be adjacent to the outer side of the thermistor body 13a of the thermistor 13. In the state, the thermistor 13 and the plate spring member 14 are press-fit into the installation concave part 15a of the thermistor accommodation part 15 located close to the rotary sensor substrate 8, with the side of the elastic piece 14d of the plate spring member 14 facing forward. At this time, the retaining piece 14e of the plate spring member 14 is engaged with the locking surface 15c of the thermistor accommodation part 15, and the thermistor 13 is retained and held in the thermistor accommodation part 15 (S8).

Inside the thermistor accommodation part 15, the elastic piece 14d of the plate spring member 14 is pressed and elastically deformed between the outer side surface of the installation concave part 15a and the thermistor 13. Then, the thermistor 13 is pressed toward the side of the wire coil 12 by using the elastic force of the elastic piece 14d, and the thermistor 13 is directly brought into contact with the wires 12a located on the inner peripheral side of the wire coil 12 from the opening part 15e of the thermistor accommodation part 15.

### Conductive Wire Connecting Process

Then, the output side of one of the of the conductive wires 13b of the thermistor 13 is routed to the output connector 9A to be guided to the outside, and the ground side of the other of the conductive wires 13b is electrically connected with the rotary sensor substrate 8 via the connector 8a (S9).

### Case Body Assembling Process

Then, the stator 3 and the insulator 11 are mounted to the case body 6.

### Front Bracket Installing Process

Then, the front bracket 4 is installed to the front side of the case body 6, and the front bracket 4 is fixed to the case body 6 by using the bolt 10b (S11).

### Rotor Assembling Process

In addition, the rotor 2 is inserted into the stator 3 from the rear side (S12).

### Rear Bracket Installing Process

Then, the rear bracket 5 is installed to the rear side of the stator 3, and then the rear bracket 5 is fixed to the case body 6 by using the bolt 10a (S13).

### Functions and Effects

As described above, the motor 1 according to the embodiment is configured to fix the busbar unit 7 concentrically to the rear side of the insulator 11. Accordingly, the busbar unit 7 can be firmly fixed to the insulator 11. As a result, the vibration which may be generated at the time of driving of the motor 1 can be properly suppressed.

In particular, it is configured that multiple insertion receiving parts 11m are provided on the inner peripheral side of the insulator 11, multiple insertion fixing parts 7b are provided on the inner peripheral side of the busbar unit 7, and the insertion fixing parts 7b are inserted into the insertion receiving parts 11m and then fixed by the adhesive 7f. Accordingly, the stress applied to the connection parts 7m between the busbar terminals 7k and the start point parts 12c and the end point parts 12b of the wire coils 12 can be reduced. Therefore, breakage of the connection part 7m due to the stress at the time of fixing the busbar unit 7 to the insulator 11 can be avoided.

Moreover, it is configured that the insertion receiving parts 11m are provided by protruding in the inner diameter direction of the insulator 11, and the insertion fixing parts 7b are provided by protruding in the inner diameter direction of the busbar unit 7. Therefore, even if each of the start point parts 12c serving as the winding start parts of the wire coils 12 and the end point parts 12b serving as the drawn parts of the wire coils 12 protrude toward the outer diameter side of the insulator 11 or the shape of the wires 12 when viewed in the axial direction is in a substantially fan shape for the purpose of increasing the space factor of the wire coils 12, the connection parts 7m between the busbar terminals 7k and the start point parts 12c and the end point parts 12b of the wire coils 12 and the insertion receiving parts 11m of the insulator 11 and the insertion fixing parts 7b of the busbar unit 7 can be disposed without layout interference.

In addition, it is configured that the through holes 7d are provided in the insertion fixing parts 7b of the busbar unit 7, the adhesive 7f is made to flow in from the through holes 7d, and the insertion fixing parts 7b of the busbar unit 7 are adhered and fixed to the insertion receiving parts 11m of the insulator 11. Therefore, after the start point part 12c and the end point part 12b of each wire coil 12 are welded and fixed to the connection parts 7m of each busbar terminal 7k of the busbar unit 7 following the assembling of the busbar unit 7 to the insulator 11, the adhesive 7f is coated on the through hole 7d and the busbar unit 7 can be fixed to the insulator 11. As a result, compared with the case where the start point part 12c and the end point part 12b of the wire coil 12 are caulked and welded after the busbar unit 7 is installed to the insulator 11 before the adhesive 7f is cured following coating of the adhesive 7f, the behavior of the adhesive 7f, which is a fluid, can be easily predicted and controlled, and the issue of having an insufficient adhesive area can be prevented. In addition, compared with the case of screwing, etc., the busbar unit 7 to be fixed to the insulator 11, the number of man-hours for assembling the busbar 7 and the cost of the motor 1 can be reduced.

In addition, it is configured so that each of the insertion receiving part 11m of the insulator 11 and the insertion fixing part 7b of the busbar unit 7 protrude toward the inner diameter side until a position covering a portion of the rotor 2, that is, in brief, it is configured so that the insertion receiving part 11m and the insertion fixing part 7b are disposed to be overlapped with the rotor 2 when viewed in the axial direction. As a result, due to the configuration in which the insertion fixing part 7b is inserted into the insertion receiving part 11m to be fixed, the fixing structure of the insertion receiving part 11m and the insertion fixing part 7b can be further secured in the radial direction. Therefore, the busbar unit 7 can be more firmly fixed.

In addition, each of the insertion receiving part 11m and the insertion fixing part 7b is configured to protrude toward the inner diameter side until a position covering a portion of the rotor 2. Therefore, the rotor 2 cannot be assembled from the rear side of the stator 3. Therefore, the motor 1 can be arranged in a three-split structure of the front bracket 4, the rear bracket 5, and the case body 6, so that the rotor 2 can be assembled from the front side of the stator 3. As a result, without changing the configuration other than the front bracket 4, the motor 1 can be made suitable for the installation target by appropriately changing the structure of the front bracket 4 to suite the installation target of the motor 1. Accordingly, for example, even for the motor for driving the side-mounted type electric motorcycle as shown in FIG. 12 or the center-mounted type electric motorcycle as shown in FIG. 13, since the motor 1 can adapt by revising the design of the front bracket 4, the versatility of the motor 1 can be significantly facilitated.

In addition, multiple insertion receiving parts 11m and multiple insertion fixing parts 7b are respectively arranged at equal intervals in the peripheral direction of the insulator 11 and the busbar unit 7. Therefore, by using the insertion receiving parts 11m and the insertion fixing parts 7b, the busbar unit 7 can be fixed to the insulator 11 at multiple places throughout the peripheral direction on the inner peripheral side. Therefore, the busbar unit 7 can be firmly fixed to the insulator 11 throughout the peripheral direction. In addition, it is configured that the insertion receiving part 11m of the insulator 11 is arranged in a concave shape, and the insertion fixing part 7b of the busbar unit 7 is inserted into the insertion receiving part 11m. Therefore, the configuration of fixing the busbar unit 7 to the insulator 11 can be simplified, and the process of assembling the busbar unit 7 to the insulator 11 can be simplified. Accordingly, the assembling property of the busbar unit 7 can be facilitated.

In addition, by forming the funnel shape in which the diameter of the through hole 7d of the busbar unit 7 is reduced in the insertion direction D, the ease of demolding when manufacturing the busbar unit 7 by using synthetic resin through injection molding or the like can be facilitated. In addition, since the portion of the through hole 7d on the inlet side where the adhesive 7f is coated becomes wider, the busbar unit 7 can be properly fixed to the insulator 11 by using a dispenser coating the adhesive 7f.

Moreover, by arranging the thickness of the busbar unit body 7a of the busbar unit 7 in the thickness direction to be greater than the thickness of the insertion fixing part 7b, the leg part 7e of the insertion fixing part 7b on the upper side can protrude toward the upper side. Therefore, the internal volume of the through hole 7d can be secured. In addition, by setting the internal volume of the through hole 7d to be greater than the coating amount of the adhesive 7f, the adhesive 7f can be prevented from overflowing from the through hole 7d.

In addition, in the motor 1 according to the embodiment, the thermistor accommodation part 15 is provided at the central position in the width direction A on the outer side of the outer wall part 11f of the insulator 11, and the opening part 15e is formed in the thermistor accommodation part 15 along the lamination direction B of the wire coil 12. In addition, by installing the thermistor 13 to the thermistor accommodation part 15, it is configured that the thermistor 13 is directly brought into contact with the wires 12a on the inner layer side of the wire coil 12 in the lamination direction B at the central position of the wire coil 12 in the width direction A.

As a result, the temperature of the wire 12a on the inner peripheral side of the wire coil 12 in the lamination direction B, where heat is most likely to accumulate and the position is likely to become a high-temperature position at the time of driving of the motor 1, etc., can be detected by the thermistor 13 from the outer side of the wire coil 12, and the temperature of the wire coil 12 can be accurately detected. Accordingly, the occurrence of an erroneous operation or a burnout failure due to melting of the insulator 11 or peeling of the coating of the wire coil 12, etc., that may occur due to the motor 1 at a high temperature can be properly suppressed, and the damage to the motor 1 can be prevented.

In brief, compared with the conventional motor in which the thermistor 13 is disposed in the wire coil 12 by winding the thermistor 13 at the time of winding the wire 12a about the wire winding part 11d of the insulator or the thermistor 13 is attached to the surface of the wire coil 12, the motor 1 is configured to provide the thermistor accommodation part 15 to protrude from the outer periphery of the insulator 11. Therefore, since it is no longer necessary to wind the thermistor 13 into the wire 12a of the wire coil 12, etc., the radial size of the peripheral part of the wire coil 12 of the motor 1 can be reduced, the radial size of the motor 1 can be reduced, and, in brief, the thickness of the motor 1 can be reduced. In addition, the temperature of the wire coil 12 can be accurately detected without reducing the space for winding the wire 12a of the insulator 11.

In addition, the thermistor accommodation part 15 is configured to protrude from the outer side surface of the outer wall part 11f of the insulator 11, and the thermistor 13 is configured to be fit and fixed to the thermistor accommodation part 15. Therefore, the physical interference due to the stator 3 or the insulator 11, etc., at the time when the thermistor 13 is installed and fixed to the thermistor accommodation part 15 can be reduced. Thus, the assembling process of the thermistor 13 can be simplified without affecting the assembling properties of the stator core 3a. In addition, the thermistor accommodation part 15 is configured to protrude from the outer side of the outer wall part 11f without increasing the thickness of the outer wall part 11f of the insulator 11 in the radial direction. Therefore, the thickness of the outer wall part 11f of the insulator 11 can be reduced. Thus, even if the insulator 11 is made of synthetic resin, the deformation at the time of molding can be suppressed. Accordingly, the insulator 11 can be accurately molded, and the assembling property of the thermistor 13 can be facilitated without affecting the assembling property of the stator core 3a.

Moreover, it is configured that the thermistor accommodation part 15 is each provided on the outer peripheral side of each of the total of 12 wire winding parts 11d of the insulator 11. As a result, the thermistor accommodation part 15 is configured to be provided in each of the respective 12-split rear-side insulator members 51 in the peripheral direction, and the rear-side insulator members 51 can be arranged in the same shape. Accordingly, even if the insulator 11 is configured to be split into 12 portions, the rear-side insulator members 51 forming the insulator 11 can be the same. Thus, the manufacturing performance of the insulator 11 can be facilitated.

In addition, the thermistor accommodation part 15 is configured to be provided between the wire fitting groove parts 11h, 11j of the insulator 11. Therefore, the central position in the width direction A, which may easily become a fragile position, in the outer wall part 11f of the insulator 11, that is, the portion between the wire fitting groove parts 11h, 11j, can be reinforced by using the thermistor accommodation part 15. Thus, the rigidity of the outer wall part 11f of the insulator 11, even the insulator 11 itself, can be facilitated. Therefore, the distortion of the insulator 11 that may be obtained in the case where a stress is applied to the outer wall part 11f of the insulator 11 at the time of winding the wire 12a about the wire winding part 11d of the insulator 11 can be suppressed.

Moreover, it is configured that the wire 12a is arranged as a flat wire, and after a side surface of the wire 12a is wound by being brought into contact with the wire winding part 11d, the side surface of the wire 12a is brought into contact with the other side surface of the wire 12a that has been wound, while the wire coil 12 is formed by aligned windings that are laminated. As a result, compared with the case where the wire 12a is arranged as a round bar wire, the thermistor 13 can be brought into contact with the wires 12a located on the inner layer side of the wire coil 12, and the contact area between the wires 12a and the thermistor 13 can be increased. Accordingly, the temperature of the wire coil 12 can be accurately detected by the thermistor 13.

In addition, it is configured that the thermistor 13 is press-fit and accommodated in the thermistor accommodation part 15 of the insulator 11 together with the plate spring member 14, and the thermistor 13 is biased and brought into contact with the wires 12a on the inner layer side of the wire coil 12 from the opening part 15e of the thermistor accommodation part 15 by pressing the thermistor 13 to the wire coil 12 by using the elastic force of the plate spring member 14. As a result, space is no longer created between the thermistor 13 and the wire coil 12. Even if an impact from the outside is received or vibration is generated due to the driving of the motor 1, such impact or vibration can be absorbed by using the elastic force of the plate spring member 14. Thus, space can be prevented from being created between the thermistor 13 and the wire coil 12 and the thermistor 13 can be prevented from deviated by using the elastic force of the plate spring 14. Accordingly, the temperature of the wire coil 12 can be properly detected by using the thermistor 13.

Moreover, it is configured that the base end part of the conductive wire 13b of the thermistor 13 is inserted through the insertion concave part 14c of the plate spring member 14, and a snap-fit structure is formed, in which the retaining piece 14e of the plate spring member 14 is engaged with the locking surface 15c of the thermistor accommodation part 15 at the time when the thermistor 13 is press-fit into the installation concave part 15a of the thermistor accommodation part 15 together with the plate spring member 14. As a result, the thermistor 13 is retained and held in the thermistor accommodation part 15 due to the plate spring member 14. Accordingly, a separate process for retaining and holding the thermistor 13 to the thermistor accommodation part 15, such as applying an adhesive or assembling a separate component, is not required. Therefore, the thermistor 13 can be easily installed to the insulator 11, and the assembling property of the thermistor 13 can be significantly facilitated.

In particular, it is configured that the thermistor 13 is retained and held in the thermistor accommodation part 15 of the insulator 11, and one plate spring 14 is used as the component that biases the thermistor 13 fixed to the thermistor accommodation part 15 and brings the thermistor 13 into contact with the wire coil 12. In addition, the configuration of biasing the thermistor 13 to the wire coil 12 and the configuration of retaining and holding the thermistor 13 in the thermistor accommodation part 15 can be properly realized by one relatively simple component, which is the plate spring member 14.

According to the above, the motor 1 according to the invention makes contribution to resolving SDG goals, such as “Goal 9: Create a foundation for industry and technological innovation” and “Goal 12: Responsibility to create and use”.

### Others

The disclosure is not limited to the embodiments described above, and includes various modifications. For example, the embodiment described above is described to explain the present invention in an easy-to-understand manner, and the disclosure is not necessarily limited to having all the configurations described.

For example, in addition to being used as a motor for driving the side-mounted type electric motor cycle shown FIG. 12 or the center-mounted electric motor cycle shown in FIGS. 13, the motor 1 according to the embodiment can also be used as the power for various electric devices with compatible driving force, such as an in-wheel type electric motorcycle driven within the wheel, or a small-sized electric vehicle.

In addition, in the embodiment, the motor 1 is configured so that the thermistor 13 is retained and held in the thermistor installation part 15 of the insulator 11 and pressed against the wire coil 12 by using the plate spring member 14. However, it can also be configured that the thermistor 13 is fixed to the thermistor installation part 15 by using an adhesive, or the thermistor 13 is fixed to the thermistor installation part 15 with a screw.

In addition, it can also be configured that the busbar unit 7 is fixed to the insulator 11 by using a bolt, press-fitting, etc., without using the adhesive 7f, as long as the deformation of the busbar unit 7 due to resonance can be suppressed.

### REFERENCE SIGNS LIST

1: Motor;
2: Rotor;
2a: Rotary shaft;
3: Stator;
3a: Stator core;
3b: Stator core body;
3c: Teeth;
4: Front bracket;
4a: Insertion hole;
5: Rear bracket;
6: Case body;
7: Busbar unit;
7a: Busbar unit body;
7b: Insertion fixing part (fixing part);
7c: Locking convex part;
7d: Through hole;
7e: Leg part;
7f: Adhesive;
7g: Inner peripheral collar part;
7h: Stepped part;
7j: Concave stepped part;
7k: Busbar terminal;
7m: Connection part;
8: Rotary sensor substrate;
8a: Connector;
9A: Output connector;
9B: Terminal holder;
9D: Terminal;
10a, 10b: Bolt;
11: Insulator;
11a: Insulator body;
11b: Inner peripheral flange;
11c: Outer peripheral flange;
11d: Wire winding part;
11e: Stator core receiving part;
11f: Outer wall part;
11g: Base part;
11h, 11j: Wire fitting groove part;
11k: Inner wall part;
11m: Insertion receiving part (receiving part);
11n: Fitting stepped part;
11p: Fitting groove part;
12: Wire coil;
12a: Wire;
12b: End point part;
12c: Start point part;
13: Thermistor (temperature detection sensor);
13a: Thermistor body;
13b: Conductive wire;
13c: Detection element;
13d: Lead wire;
14: Plate spring member (biasing member);
14a: Plate spring body;
14b: Bent part;
14c: Insertion concave part;
14d: Elastic piece;
14e: Retaining piece;
15: Thermistor accommodation part (accommodation part);
15a: Installation concave part;
15b: Locking groove;
15c: Locking surface;
15d: Accommodation concave part;
15e: Opening part;
15f: Locking piece ;
31: Stator member;
31a: Uneven surface;
51: Rear-side insulator member;
61: Front-side insulator member;
A: Width direction;
B: Lamination direction;
C: Clearance;

D: Insertion direction.

1. A motor, comprising:
a stator;
a rotor, rotatably installed;
an insulator, installed to the stator, and having a cylindrical shape which exhibits
an insulating property and in which a plurality of wire winding parts are arranged in a peripheral direction;
a plurality of wire coils, formed by winding wires about the respective wire winding parts of the insulator; and
a temperature detection sensor, detecting a temperature of the wire coil,
wherein an opening part for bringing the temperature detection sensor into contact with the wire coil is provided on an outer peripheral side of at least one of the wire winding parts, and
the opening part is formed along a lamination direction of the wire coil.

2. The motor as claimed in claim 1, wherein the opening part is provided in each of the wire winding parts, and
the temperature detection sensor is fixed to at least one of the wire winding parts.

3. The motor as claimed in claim 1, wherein, on the outer peripheral side of the wire winding part where the opening part is provided, an accommodation part able to accommodate the temperature detection sensor is provided to be protrusive toward the outer peripheral side, and
the temperature detection sensor is accommodated in the accommodation part so as to contact the wire coil from the opening part.

4. The motor as claimed in claim 3, wherein the wire coil is provided about the wire winding part by winding the wire with a radial direction of the insulator as a central axis direction, and has a width direction orthogonal to each of an axial direction and the radial direction of the insulator,
the accommodation part is provided along the axial direction of the insulator at a central position of the wire coil in the width direction, and
the temperature detection sensor is brought into contact with a wire on an inner layer side of the wire coil from the opening part and accommodated in the accommodation part.

5. The motor as claimed in claim 4, wherein the wire coil has a start point part and an end point part of the wire, the start point part is provided at the wire winding part by protruding from a side part of the wire coil in the width direction, and the end point part is provided at the wire winding part by protruding from an other side part of the wire coil in the width direction, and
the accommodation part is provided between the start point part and the end point part.

6. The motor as claimed in claim 4,
wherein the wire is a flat wire having a rectangular cross-sectional shape,
the wire coil is configured by laminating and winding a surface of the wire, and
the temperature detection sensor is brought into contact and fixed to a plurality of wires located on the inner layer side of the wire coil.

7. The motor as claimed in claim 1, comprising: a biasing member, biasing the temperature detection sensor toward the wire coil.

8. The motor as claimed in claim 3, comprising: a biasing member, biasing the temperature detection sensor toward the wire coil,
a locking groove is provided on an outer peripheral side of the accommodation part, and
the biasing member locks the temperature detection sensor to the locking groove in a state in which the temperature detection sensor is accommodated in the accommodation part, and has a retaining piece that retains and holds the temperature detection sensor from the accommodation part.

9. The motor as claimed in claim 8, wherein the biasing member is a plate spring member that is attached to an outer peripheral side of the temperature detection sensor, accommodated in the accommodation part together with the temperature detection sensor, and biases the temperature detection sensor toward the wire coil by using an elastic force generated between the biasing member and the outer peripheral surface of the accommodation part.
